(19) United States
(12) Patent Application Publication
(10) Pub. No.: US 2021/0025984 A1
(43) Pub. Date: Jan. 28, 2021

(54) GLASS WINDOWS FOR LIDAR APPLICATIONS

(71) Applicant: SCHOTT AG, Mainz (DE)

(72) Inventors: Nikolaus Schultz, Essenheim (DE); Boris Eichhorn, Mainz (DE); Frank-Thomas Lentes, Bingen (DE); Jens Ulrich Thomas, Stralsund (DE); Volker Plapper, Alzey (DE)

(21) Appl. No.: 16/935,732

(22) Filed: Jul. 22, 2020

(30) Foreign Application Priority Data
Jul. 23, 2019 (EP) 19187909.7
Dec. 4, 2019 (EP) 19213558.0
Mar. 5, 2020 (EP) 20161338.7

(51) Int. Cl. G01S 7/481; G02B 5/20; G02B 1/11

(52) U.S. Cl. CPC G01S 7/4813; G01S 7/4817; G02B 1/11; G02B 5/208; G01S 7/4814

(57) ABSTRACT

The disclosure relates to a glass window for optical systems, in particular for LiDAR systems, in which the glass window has a curved form. For length scales between 0.1 mm and 15 mm, at least 50% of the area of the glass window has a geometrical slope error SE_{G} for which the following is true: SE_{G}<−2.3·10⁻⁶·2·R₀[1/mm]+7.3·10⁻⁴.

### CROSS-REFERENCE TO RELATED APPLICATIONS

The present application claims priority to European Patent Application No. EP 19 18 7909.7, filed Jul. 23, 2019, European Patent Application No. EP 19 21 3558.0, filed Dec. 4, 2019, and European Patent Application No. EP 20 16 1338.7, filed Mar. 5, 2020, each of which is incorporated herein by reference.

### SUMMARY OF THE DISCLOSURE

### 1. Field of the Disclosure

The present disclosure relates to a glass window for optical systems and instruments, in particular for LiDAR systems (LiDAR: light detection and ranging). Furthermore, the disclosure relates to a LiDAR system with such a glass window as well as a method for the manufacturing of such a glass window.

### 2. Description of the Related Art

LiDAR (abbreviation for “light detection and ranging”) or also LaDAR (abbreviation for “laser detection and ranging”) is a method for optical measurement of distance and velocity by means of laser light, in the following referred to as LIDAR. For that LiDAR systems emit laser radiation in the near infrared spectrum (NIR), that is laser radiation with wavelengths of higher than 780 nm, which is reflected from objects in the surroundings and at least partially again reaches the LiDAR system and is detected there. From the pattern of the reflected radiation the LiDAR system is able to identify objects and from the time of flight of the laser radiation it is able to calculate the distance of the objects. Some LiDAR systems can also calculate the velocity of objects on the basis of phase relationships of the emitted and reflected radiation.

Currently, LiDAR systems and/or LiDAR sensors are an important component for realizing autonomous driving. Further uses and fields of application for LiDAR systems are, for example, robot taxis, robot trucks, robot air taxis, industry and logistics robots, drones, marine and ships, mining, construction machines and mining machinery, security and military, space satellites as well as the preparation of topology maps/maps from the air, of the country and underwater, the optimization of wind turbines, the measurement of turbulences at airports, the determination of airplane turbulences, etc.

All LiDAR systems require at least one optical window which is arranged between the optoelectronic components of the LiDAR system and the surroundings and provides a mechanical protection against environmental influences. In an ideal case, the optical window can even guarantee a hermetic seal between the optoelectronic components of the LiDAR system and the surroundings. The different LiDAR systems can be distinguished according to their construction design, and more precisely with respect to the shape and construction design of the windows used in the LiDAR systems. Some LiDAR systems are provided with planar windows for separating the sensible components of the system from the environment. Instead of planar windows, other LiDAR systems comprise arced or curved windows. Also broadly used are rotating LiDAR systems (spinning LiDAR systems) in which emitter and detector rotate in a typically stationary ring window.

In known LiDAR systems mostly windows of polymer material are used, in particular for spinning LiDAR systems and other LiDAR systems with curved windows. Mostly, these polymer windows are prepared of materials such as for example polycarbonate (PC) or polymethyl methacrylate (PMMA) by means of a melt forming or injection molding method. However, LiDAR windows of polymer materials have disadvantages with respect to their service life and reliability.

Polymer windows often have an increased susceptibility to scratches due to their low scratch resistance. Scratches in the polymer windows during the operation of the LiDAR system can be generated by (a) environmental influences due to little impacting particles (e.g. sand in the air or particles of cars running ahead), by (b) mechanical cleaning of the window and/or by (c) hard material or sand which scratches over the surface of the window, when windshield wipers are used. Scratched surfaces through which light to be reflected and reflected light have to pass enormously compromise the optical performance and reliability of the system, in particular by reduction of light, misallocation of light onto false pixels, scattering and reduction of the signal/noise ratio.

A further disadvantage of prior art polymer windows is a poor adhesion of additional layers on the polymer windows. Often, LiDAR windows can be connected with additional layers for improving certain optical, physical and/or mechanical properties. Due to the poor adhesive properties of the polymer windows often these additional layers are at least partially detached which reduces the signal strengths and thus the signal/noise ratios. In addition, locally detached coatings result in undesired jumps of the signal strengths. The adhesive properties are further diminished, when besides optically active coatings further layers such as anti-scratch layers or water-repellent layers are applied.

Furthermore, polymer windows have a low and often insufficient environmental stability. Polymers are organic materials which under UV irradiation normally discolor (brown coloration). Such a discoloration results in reduction of signal strengths. Polycarbonate, for example, is relatively UV stable, but nevertheless users often complain of a UV stability which is too low for LiDAR uses. In addition, the polymer surface degrades by weather influences, such as for example by atmospheric deposits (after a chemical reaction) which also reduces the signal strength.

In addition, polymer windows are not gas-tight so that after a short time in LiDAR systems the same humidity like in the surrounding atmosphere is present, because water vapor diffuses through the polymer material. Humidity in the system may lead to corrosion and mechanical failure of the system.

Furthermore, polymer materials have a relatively low melting temperature. This is in particular critical in the case of LiDAR systems in which heating layers are applied onto the window, because here exists the risk of melting the window, when the heating layers are overheated. Melting of the window would destroy the functional capability of the whole LiDAR system.

Due to the various disadvantages of polymer windows there is the idea to use glass materials for LiDAR windows. Such a window is, for example, disclosed in the documents WO 2019/030106 A1 and WO 2019/009336 A1. But neither the glass windows which are described in prior art nor other glass windows which are known from the practice are really suitable for the use in LiDAR systems, because, when hitherto existing glass windows are used, due to natural tolerances signal fluctuations which are too high occur.

One object of the present disclosure is to overcome the disadvantages of prior art. In particular, one object of the disclosure is to provide a window for optical systems which overcomes the disadvantages of prior art and is suitable for the use in LiDAR systems.

### SUMMARY OF THE DISCLOSURE

One aspect of the disclosure relates to a glass window for optical systems or applications, in particular for LiDAR systems. The glass window can be installable in an optical system, in particular in a LiDAR system. The glass window according to the present disclosure can also be suitable for other optical instruments, in particular for optical instruments having ring geometries. The glass window has a curved form or area and thus is different from pure flat glasses. A curved form means that the glass window has a three-dimensionally curved shape. The glass window can be curved around one or more bending axes, i.e. uniaxial or multiaxial. For example, the curved glass window can have the form of a ring, ring segment (sector or segment of a circle), spiral segment or curved free form surface area or may be asymmetrically curved. The glass window can have one or more curvatures, wherein several curvatures of the glass window may be the same or different. The glass window can be curved in a certain region and may not be curved in another region. It can be that the glass window is not curved, i.e. may have a straight form, in axial direction. “Glass” in the context of the present disclosure may also comprise glass ceramics. In preferable embodiments, however, the term “glass” only comprises amorphous material.

For length scales between 0.1 mm and 15 mm, at least 50% of the area of the glass window has a geometrical slope error SE_{G} for which the following applies:

SE_{G}<−2.3·10⁻⁶·2·R₀[1/mm]+7.3·10⁻⁴;

preferably SE_{G}<−1.1·10⁻⁶·2·R₀[1/mm]+3.6·10⁻⁴;

preferably SE_{G}<−6.8·10⁻⁷·2·R₀[1/mm]+2.2·10⁻⁴,

wherein SE_{G} is the dimensionless geometrical slope error and R₀ is the target value of the radius of curvature (in mm) of the glass window. In particular, R₀ can be the target value of the radius of curvature of the glass window at the position of the glass window at which the slope error is examined. For the calculation of the slope error, as reference area an ideal area each at the examined position of the glass window is used. In particular, the target value of the radius of curvature R₀ can be the target value of the radius of curvature based on an outer surface of the glass window, thus a target value of the outer radius of curvature.

The term “target value” is used for convenience herein, and can also mean a “reference value” or “desired value”. These terms refer to the theoretical value (e.g. radius) that the glass window should have at a certain position or region. The real, actual, or measured value may slightly deviate from this target, reference, or desired value, e.g. due to slope errors.

The condition according to the present disclosure defines for the first time exact values for the slope error which are to be met depending on the target value of the radius of curvature. The slope error may also be referred to as tangent error and describes a local slope deviation with respect to an ideal target value of the curvature or a change of the wall thickness over a length section, for example a circumferential section (wall thickness fluctuation), wherein the value of the slope error according to the present disclosure is not dependent on the orientation (axial or tangential) of the structures. When the slope error is examined and determined, then as reference area the ideal area each at the respective position of the glass window is used. In the case of a glass window having the form of a glass ring, this would, for example, be a ring which is perfect in mathematic respect and has a target value of the radius of curvature which is consistently identical.

The present disclosure, for the first time, defines a clear recommended course of action for providing glass windows with precise properties and tolerances which have to be adjusted with respect to the surface quality and performance which are required for allowing a use of the glass window for LiDAR applications. In particular, the disclosure defines by the specified condition explicit limits for the slope error which have to be met in dependence on a target value of the radius of curvature of the glass window.

Until now, glass windows often have not been suitable for LiDAR uses due to natural tolerances and thus created too high signal fluctuations. In this context it is to be mentioned that the quantification of the here defined parameters, tolerances and properties strongly depends on a plurality of influencing factors, such as for example the imaging properties which are required for the respective use, the wavelengths which are normally used in the application, the exact geometries of the optical elements, the optoelectronic components and the analysis software, etc. Therefore, the definition of upper limits for a special system (here in particular a LiDAR system) rests upon a substantial technology development by the inventors which is the basis of the disclosure.

In this connection, the inventors have found that for being suitable in LiDAR systems it is surprisingly allowed for the glass window to have relatively high tolerances with respect to many parameters. However, it has been found that for an optimum system performance and a suitable signal quality especially the parameter of the geometrical and preferably the optical slope error is relevant. According to the present disclosure, the slope error, which takes the dimensionless ratio of the wall thickness change over a length into account, has to be kept within the above defined tolerances or values. In this connection, the inventors have particularly found within which ranges the slope error in dependence on a target value of the curvature of the glass window has to be provided for being able to meet the requirements of LiDAR systems.

For providing a glass window according to the present disclosure or achieving the required values of the slope error, the glass window can, for example, be post-treated by means of a grinding and/or polishing process. In addition, the inventors have found that in particular wall thickness fluctuations in lengths of AL =0.1 mm to 15 mm are relevant for the suitability to be achieved of the glass window for LiDAR systems. Shorter wave fluctuations lead physically to scattering effects and are normally described via the roughness and specified by means of roughness parameters, longer wave fluctuations are less strongly detected from the LiDAR system, because they are in the order of the optical aperture. They may result in a change between the true and an apparent angle direction. A glass window with the values according to the present disclosure for the geometrical and preferably the optical slope error for length scales between 0.1 mm and 15 mm allows to minimize a signal fluctuation and to keep it within a tolerance range of +/−10%, which is considered to be sufficient, when the glass window is used in LiDAR systems. The use of a glass window with the values according to the present disclosure for the geometrical and preferably the optical slope error for length scales between 0.1 mm and 15 mm allows relative standard deviations of the LiDAR signal from the mean value in relation to the mean value of less than 10%, preferably less than 7%, preferably less than 6%, still further preferably less than 4%. The standard deviation can be calculated by means of n measurements of the normalized signal strength of the LiDAR signal at different window positions, in the case of windows in ring form in particular at different rotation angels of the window. The standard deviation s can be calculated as follows, wherein are the single measuring values and χ is their mean value. n may preferably be at least 5, or at least 7. In an embodiment n=9.

$$\tilde{s} \text{:=} + \sqrt{\frac{1}{n} {\sum }_{i = 1}^{n} {( {x}_{i} - \overline{x} )}^{2}}$$

The geometrical slope error can be measured by means of white light interferometry. In an embodiment the glass window may have a target value of the radius of curvature of R₀=42.5 mm. For example, the glass window may have a target value of the outer diameter OD=85 mm. In this case, for length scales between 0.1 mm and 15 mm 50% of the area of the glass window may have a geometrical slope error SE_{G} of less than 0.0005345, preferably of less than 0.0002665, preferably of less than 0.0001622. In this embodiment, for example, the glass window may be a glass ring.

In an embodiment, the glass window may have a target value of the radius of curvature of R₀=67.5 mm. For example, the glass window may have a target value of the outer diameter OD=135 mm. In this case, for length scales between 0.1 mm and 15 mm 50% of the area of the glass window may have a geometrical slope error SE_{G} of less than 0.0004195, preferably of less than 0.0002115, preferably of less than 0.0001282. In this embodiment, for example, the glass window may be a glass ring.

In a development for length scales between 0.1 mm and 15 mm, at least 50% of the area of the glass window may have a lower limit for the geometrical slope error SE_{G}. So length scales between 0.1 mm and 15 mm at least 50% of the area of the glass window may have a geometrical slope error SE_{G} for which the following applies:

SE_{G}>−6.8·10⁻⁸·2·R₀[1/mm]+2.2·10⁻⁵;

preferably SE_{G}>−1.1·10⁻⁷·2·R₀[1/mm]+3.6·10⁻⁵;

preferably SE_{G}>−2.3·10⁻⁷·2·R₀[1/mm]+7.3·10⁻⁵,

wherein SE_{G} is the dimensionless geometrical slope error and R₀ is the target value of the radius of curvature (in mm) of the glass window. In particular, R₀ can be the target value of the radius of curvature of the glass window at the position of the glass window at which the slope error is examined.

In an embodiment, the glass window may have a target value of the radius of curvature of R₀=42.5 mm. For example, the glass window may have a target value of the outer diameter OD=85 mm. In this case, for length scales between 0.1 mm and 15 mm 50% of the area of the glass window may have a geometrical slope error SE_{G} of at least 0.0000162, preferably of at least 0.0000267, preferably of at least 0.0000535. In this embodiment, for example, the glass window may be a glass ring.

In an embodiment, the glass window may have a target value of the radius of curvature of R₀=67.5 mm. For example, the glass window may have a target value of the outer diameter OD=135 mm. In this case, for length scales between 0.1 mm and 15 mm, 50% of the area of the glass window may have a geometrical slope error SE_{G} of at least 0.0000128, preferably of at least 0.0000212, preferably of less than 0.0000420. In this embodiment, for example, the glass window may be a glass ring.

In a development for length scales between 0.1 mm and 15 mm, at least 50% of the area of the glass window may have a geometrical slope error SE_{G} for which the following applies:

−6.8·10⁻⁸·2·R₀[1/mm]+2.2·10⁻⁵<SE_{G}<−2.3·10⁻⁶·2·R₀[1/mm]+7.3·10⁻⁴;

preferably −1.1·10⁻⁷·2·R₀[1/mm]+3.6·10⁻⁵<SE_{G}<−1.1·10⁻⁶·2·R₀[1/mm]+3.6·10⁻⁴;

preferably −2.3·10⁻⁷·2·R₀[1/mm]+7.3·10⁻⁵<SE_{G}<−6.8·10⁻⁷·2·R₀[1/mm]+2.2·10⁻⁴,

wherein SE_{G} is the dimensionless geometrical slope error and R₀ is the target value of the radius of curvature (in mm) of the glass window. In particular, R₀ can be the target value of the radius of curvature of the glass window at the position of the glass window at which the slope error is examined.

In a development for length scales between 0.1 mm and 15 mm, at least 50% of the area of the glass window may have a geometrical slope error of less than 0.00050, preferably less than 0.00040, preferably less than 0.00035, further preferably less than 0.00025(=2.5·10⁻⁴). In particular, at least 50% of the area of the glass window for length scales between 0.1 mm and 15 mm may have a geometrical slope error of at least 0.00001, preferably at least 0.000025, preferably at least 0.00004. For example, at least 50% of the area of the glass window for length scales between 0.1 mm and 15 mm may have a geometrical slope error of between 0.00001 and 0.00040, preferably between 0.000025 and 0.00035, preferably between 0.00005 and 0.00025.

In other words, for the geometrical slope error in at least 50% of the area of the glass window for length scales between 0.1 mm and 15 mm the following relation may be true:

0<(ΔWT)/ΔL<X,

wherein WT is the wall thickness in mm and Lisa length in mm of the glass window and Xis a variable for the above defined values. In particular, it may be that X=2.5·10⁻⁴.

In a development for length scales between 0.1 mm and 15 mm, at least 50% of the area of the glass window may have an optical slope error SE_{O} for which the following applies:

SE_{O}<−1.1·10⁻⁶·2·R₀[1/mm]+3.6·10⁻⁴;

preferably SE_{O}<−5.6−10⁻⁷·2·R₀[1/mm]+1.8·10⁻⁴;

preferably SE_{O}<−3.4·10⁻⁷·2·R₀[1/mm]+1.1·10⁻⁴,

wherein SE_{O} is the dimensionless optical slope error and R₀ is the target value of the radius of curvature (in mm) of the glass window. In particular, R₀ may be the target value of the radius of curvature of the glass window at the position of the glass window at which the slope error is examined.

In an embodiment, the glass window may have a target value of the radius of curvature of R₀=42.5 mm. For example, the glass window may have a target value of the outer diameter OD=85 mm. In this case, for length scales between 0.1 mm and 15 mm 50% of the area of the glass window may have an optical slope error SE_{O} of less than 0.000267, preferably of less than 0.000133, preferably of less than 0.000081. In this embodiment, for example, the glass window may be a glass ring.

In an embodiment, the glass window may have a target value of the radius of curvature of R₀=67.5 mm. For example, the glass window may have a target value of the outer diameter OD=135 mm. In this case, for length scales between 0.1 mm and 15 mm, 50% of the area of the glass window may have an optical slope error SE_{O} of less than 0.000212, preferably of less than 0.000104, preferably of less than 0.000064. In this embodiment, for example, the glass window may be a glass ring.

In a development, for length scales between 0.1 mm and 15 mm, at least 50% of the area of the glass window may have a lower limit for the optical slope error SE_{O}. So for length scales between 0.1 mm and 15 mm, at least 50% of the area of the glass window may have an optical slope error SE_{O} for which the following applies:

SE_{O}>−3.4·10⁻⁸·2·R₀[1/mm]+1.1·10⁻⁵;

preferably SE_{O}>−5.6·10⁻⁸·2·R₀[1/mm]+1.8·10⁻⁵;

preferably SE_{O}>−1.1·10⁻⁷·2·R₀[1/mm]+3.6·10⁻⁵,

wherein SE_{O} is the dimensionless optical slope error and R₀ is the target value of the radius of curvature (in mm) of the glass window. In particular, R₀ can be the target value of the radius of curvature of the glass window at the position of the glass window at which the slope error is examined.

In an embodiment, the glass window may have a target value of the radius of curvature of R₀=42.5 mm. For example, the glass window may have a target value of the outer diameter OD=85 mm. In this case, for length scales between 0.1 mm and 15 mm, 50% of the area of the glass window may have an optical slope error SE_{O} of at least 0.000008, preferably of at least 0.000013, preferably of at least 0.000027. In this embodiment, for example, the glass window may be a glass ring.

In an embodiment, the glass window may have a target value of the radius of curvature of R₀=67.5 mm. For example, the glass window may have a target value of the outer diameter OD=135 mm. In this case, for length scales between 0.1 mm and 15 mm, 50% of the area of the glass window may have an optical slope error SE_{O} of at least 0.000006, preferably of at least 0.000010, preferably of at least 0.000021. In this embodiment, for example, the glass window may be a glass ring.

In an embodiment, for length scales between 0.1 mm and 15 mm, at least 50% of the area of the glass window may have an optical slope error SE_{O} for which the following applies:

−3.4·10⁻⁸·2·R₀[1/mm]+1.1·10⁻⁵<SE_{O}<−1.1·10⁻⁶·2·R₀[1/mm]+3.6·10⁻⁴;

preferably −5.6·10⁻⁸·2·R₀[1/mm]+1.8·10⁻⁵<SE_{O}<−5.6·10⁻⁷·2·R₀[1/mm]+1.8·10⁻⁴;

preferably −1.1·10⁻⁷·2·R₀[1/mm]+3.6·10⁻⁵<SE_{O}<−3.4·10⁻⁷·2·R₀ [1/mm]+1.1·10⁻⁴,

wherein SE_{O} is the dimensionless optical slope error and R₀ is the target value of the radius of curvature (in mm) of the glass window. In particular, R₀ can be the target value of the radius of curvature of the glass window at the position of the glass window at which the slope error is examined.

In an embodiment, for length scales between 0.1 mm and 15 mm, at least 50% of the area of the glass window may have an optical slope error of less than 0.00025, preferably less than 0.00020, preferably less than 0.00018, further preferably less than 0.00013(=1.3·10⁻⁴). In particular, at least 50% of the area of the glass window for length scales between 0.1 mm and 15 mm may have an optical slope error of at least 0.000005, preferably at least 0.000013, preferably at least 0.00002. For example, at least 50% of the area of the glass window for length scales between 0.1 mm and 15 mm may have an optical slope error of between 0.000005 and 0.00025, preferably between 0.000013 and 0.00020, preferably between 0.00002 and 0.00013.

In other words, for the optical slope error in at least 50% of the area of the glass window for length scales between 0.1 mm and 15 mm the following relation may be true:

0<(n−1)*(ΔWT)/ΔL<X,

wherein WT is the wall thickness in mm, Lisa length in mm and n is the refractive index of the glass window for a laser wavelength of 905 nm and X is a variable for the above defined values. In particular, it may be that X=1.3·10⁻⁴.

The substantial difference between the geometrical slope error and the optical slope error is that the geometrical slope error takes a geometrical change of the wall thickness (as sum of both sides) in relation to the examined length into account. A change of the wall thickness results in a changed transmission of the wave front which can be described by the optical slope error which besides the geometrical parameters also takes the refractive index of the material used into account. In particular, it is possible that both sides or surfaces of the glass window which are opposite to each other have the above defined values of the optical slope error.

Preferably, the glass window has this tolerable maximum of the geometrical slope error or a geometrical slope error which is lower than this tolerable maximum and/or this tolerable maximum of the optical slope error or an optical slope error which is lower than this tolerable maximum in at least 60% of its area, preferably at least 70%, further preferably at least 80%, still further preferably at least 90%. In other words, the glass window has the high surface quality and performance which is described by the maximum slope error in a sufficient extent in at least the part of the glass window which, when the glass window is used in an optical system, for example in a LiDAR system, is actively used from the system. In particular, in the case of LiDAR systems, this is the part of the glass window through which a laser light (emitted and reflected) passes.

In an embodiment of the disclosure, the glass window may have a curved form and in an area of the glass window of at least 100 mm² for length scales between 0.1 mm and 15 mm a geometrical slope error for which the following applies:

SE_{G}<−2.340⁻⁶·2·R₀[1/mm]+7.3·10⁻⁴;

preferably SE_{G}<−1.1·10⁻⁶·2·R₀[1/mm]+3.6·10⁻⁴;

preferably SE_{G}<−6.8·10⁻⁷·2·R₀[1/mm]+2.2·10⁻⁴,

wherein SE_{G} is the dimensionless geometrical slope error and R₀ is the target value of the radius of curvature (in mm) of the glass window. In particular, R₀ can be the target value of the radius of curvature of the glass window at the position of the glass window at which the slope error is examined.

In an embodiment of the disclosure, the glass window may have a curved form and in an area of the glass window of at least 100 mm² a geometrical slope error of less than 0.00050, preferably less than 0.00040, preferably less than 0.00035, further preferably less than 0.00025(=2.5·10⁻⁴), for length scales between 0.1 mm and 15 mm. In an embodiment of the disclosure, the glass window may have a curved form and for length scales between 0.1 mm and 15 mm in an area of the glass window of at least 100 mm² a geometrical slope error for which the following applies:

SE_{G}>−6.8·10⁻⁸·2·R₀[1/mm]+2.2·10⁻⁵;

preferably SE_{G}>−1.1·10⁻⁷·2·R₀[1/mm]+3.6·10⁻⁵;

preferably SE_{G}>−2.3·10⁻⁷·2·R₀[1/mm]+7.3·10⁻⁵,

wherein SE_{G} is the dimensionless geometrical slope error and R₀ is the target value of the radius of curvature (in mm) of the glass window. In particular, R₀ can be the target value of the radius of curvature of the glass window at the position of the glass window at which the slope error is examined.

In a development, the glass window may have a curved form and for length scales between 0.1 mm and 15 mm in an area of the glass window of at least 100 mm² a geometrical slope error for which the following applies:

−6.8·10⁻⁸−2·R₀[1/mm]+2.2·10⁻⁵<SE_{G}<−2.3·10⁻⁶·2·R₀[1/mm]+7.3·10⁻⁴;

preferably −1.1·10⁻⁷·2·R₀[1/mm]+3.6·10⁻⁵<SE_{G}<−1.1·10⁻⁶·2·R₀[1/mm]+3.6·10⁻⁴;

preferably −2.3·10⁻⁷·2·R₀[1/mm]+7.3·10⁻⁵<SE_{G}<−6.8·10⁻⁷·2·R₀[1/mm]+2.2·10⁻⁴,

wherein SE_{G} is the dimensionless geometrical slope error and R₀ is the target value of the radius of curvature (in mm) of the glass window. In particular, R₀ can be the target value of the radius of curvature of the glass window at the position of the glass window at which the slope error is examined.

In an embodiment of the disclosure, the glass window may have a curved form and for length scales between 0.1 mm and 15 mm in an area of the glass window of at least 100 mm² an optical slope error SE_{O} for which the following applies:

SE_{O}<−1.1·10⁻⁶·2·R₀[1/mm]+3.6·10⁻⁴;

preferably SE_{O}<−5.6·10⁻⁷·2·R₀[1/mm]+1.8·10⁻⁴;

preferably SE_{O}<−3.4·10⁻⁷·2·R₀[1/mm]+1.1·10⁻⁴,

wherein SE_{O} is the dimensionless optical slope error and R₀ is the target value of the radius of curvature (in mm) of the glass window. In particular, R₀ can be the target value of the radius of curvature of the glass window at the position of the glass window at which the slope error is examined.

In an embodiment of the disclosure, the glass window may have a curved form and for length scales between 0.1 mm and 15 mm in an area of the glass window of at least 100 mm² an optical slope error SE_{O} for which the following applies:

SE_{O}>−3.4·10⁻⁸·2·R₀[1/mm]+1.1·10⁻⁵;

preferably SE_{O}>−5.6·10⁻⁸·2·R₀[1/mm]+1.8·10⁻⁵;

preferably SE_{O}>−1.1·10⁻⁷·2·R₀[1/mm]+3.6·10⁻⁵,

wherein SE_{O} is the dimensionless optical slope error and R₀ is the target value of the radius of curvature (in mm) of the glass window. In particular, R₀ can be the target value of the radius of curvature of the glass window at the position of the glass window at which the slope error is examined.

In an embodiment of the disclosure, the glass window may have a curved form and for length scales between 0.1 mm and 15 mm in an area of the glass window of at least 100 mm² an optical slope error SE_{O} for which the following applies:

−3.4·10⁻⁸·2·R₀[1/mm]+1.1·10⁻⁵<SE_{O}<−1.1·10⁻⁶·2·R₀[1/mm]+3.6·10⁻⁴;

preferably −5.6·10⁻⁸·2·R₀[1/mm]+1.8·10⁻⁵<SE_{O}<−5.6−10⁻²·2·R₀[1/mm]+1.8·10⁻⁴;

preferably −1.1·10⁻²·2·R₀[1/mm]+3.6·10⁻⁵<SE_{O}<−3.4·10⁻²·2·R₀[1/mm]+1.1·10⁻⁴,

wherein SE_{O} is the dimensionless optical slope error and R₀ is the target value of the radius of curvature (in mm) of the glass window. In particular, R₀ can be the target value of the radius of curvature of the glass window at the position of the glass window at which the slope error is examined.

In particular, for length scales between 0.1 mm and 15 mm, an area of the glass window of at least 100 mm² may have a geometrical slope error of at least 0.00001, preferably at least 0.000025, preferably at least 0.00004. For example, an area of the glass window of at least 100 mm² for length scales between 0.1 mm and 15 mm may have a geometrical slope error of between 0.00001 and 0.00040, preferably between 0.000025 and 0.00035, preferably between 0.00005 and 0.00025.

Preferably, the glass window has this tolerable maximum of the geometrical slope error or a geometrical slope error which is lower than this tolerable maximum and/or this tolerable maximum of the optical slope error or an optical slope error which is lower than this tolerable maximum in an area of at least 100 mm², preferably at least 500 mm², further preferably at least 1000 mm², still further preferably at least 1 m².

For example, the glass window has this tolerable maximum of the geometrical slope error or a geometrical slope error which is lower than this tolerable maximum and/or this tolerable maximum of the optical slope error or an optical slope error which is lower than this tolerable maximum in an area of 250000 mm² or less, preferably 30000 mm² or less, further preferably 1500 mm² or less.

In particular, the glass window has this tolerable maximum of the geometrical slope error or a geometrical slope error which is lower than this tolerable maximum and/or this tolerable maximum of the optical slope error or an optical slope error which is lower than this tolerable maximum in an area of between 100 mm² and 250000 mm², preferably between 500 mm² and 30000 mm², in particular between 1000 mm² and 1500 mm².

In other words, the glass window has the high surface quality and performance which is described by the maximum slope error in a sufficient extent in at least the part of the glass window which, when the glass window is used in an optical system, for example in a LiDAR system, is actively used from the system. In particular, in the case of LiDAR systems, this is the part of the glass window through which a laser light (emitted and reflected) passes.

In a development, for length scales above 15 mm, in particular for length scales between 15 mm and the half of the circumference (U/2) in mm of a ring-shaped glass window, at least 50% of the area of the glass window may have a geometrical slope error SE_{G} for which the following applies:

SE_{G}<−4.8·10⁻⁵·2·R₀[1/mm]+9.8·10⁻³;

preferably SE_{G}<−2.4·10⁻⁵·2·R₀[1/mm]+4.9·10⁻³;

preferably SE_{G}<−9.7·10⁻⁶·2·R₀[1/mm]+2.0·10⁻³,

wherein SE_{G} is the dimensionless geometrical slope error and R₀ is the target value of the radius of curvature (in mm) of the glass window. In particular, R₀ can be the target value of the radius of curvature of the glass window at the position of the glass window at which the slope error is examined.

In an embodiment, the glass window may have a target value of the radius of curvature of R₀=42.5 mm. For example, the glass window may have a target value of the outer diameter OD=85 mm. In this case, for length scales above 15 mm, in particular for length scales between 15 mm and the half of the circumference (U/2) in mm of a ring-shaped glass window, 50% of the area of the glass window may have a geometrical slope error SE_{G} of less than 0.0057, preferably of less than 0.0029, preferably of less than 0.0011. In this embodiment, for example, the glass window may be a glass ring.

In an embodiment, the geometrical slope error may have a lower limit. So, for length scales above 15 mm, in particular for length scales between 15 mm and the half of the circumference (U/2) in mm of a ring-shaped glass window, at least 50% of the area of the glass window may have a geometrical slope error SE_{G} for which the following applies:

SE_{G}>−9.7·10⁻⁷·2·R₀[1/mm]+2.0·10⁻⁴;

preferably SE_{G}>−2.4·10⁻⁶·2·R₀[1/mm]+4.9·10⁻⁴;

preferably SE_{G}>−4.8·10⁻⁶·2·R₀[1/mm]+9.8·10⁻⁴,

wherein SE_{G} is the dimensionless geometrical slope error and R₀ is the target value of the radius of curvature (in mm) of the glass window. In particular, R₀ can be the target value of the radius of curvature of the glass window at the position of the glass window at which the slope error is examined.

In an embodiment, the glass window may have a target value of the radius of curvature of R₀=42.5 mm. For example, the glass window may have a target value of the outer diameter OD=85 mm. In this case, for length scales above 15 mm, in particular for length scales between 15 mm and the half of the circumference (U/2) in mm of a ring-shaped glass window, 50% of the area of the glass window may have a geometrical slope error SE_{G} of at least 0.00011, preferably of at least 0.00029, preferably of at least 0.00057. In this embodiment, for example, the glass window may be a glass ring.

In an embodiment, at least 50% of the area of the glass window for length scales above 15 mm, in particular for length scales between 15 mm and the half of the circumference (U/2) in mm of a ring-shaped glass window, may have a geometrical slope error SE_{G} for which the following applies:

−9.7·10⁻⁷·2·R₀[1/mm]+2.0·10⁻⁴<SE_{G}<−4.8·10⁻⁵·2·R₀[1/mm]+9.8·10⁻³;

preferably −2.4·10⁻⁶·2·R₀[1/mm]+4.9·10⁻⁴<SE_{G}<−2.4·10⁻⁵·2·R₀[1/mm]+4.9·10⁻³;

preferably −4.8·10⁻⁶·2·R₀[1/mm]+9.8·10⁻⁴<SE_{G}<−9.7·10⁻⁶·2·R₀[1/mm]+2.0·10⁻³,

wherein SE_{G} is the dimensionless geometrical slope error and R₀ is the target value of the radius of curvature (in mm) of the glass window. In particular, R₀ can be the target value of the radius of curvature of the glass window at the position of the glass window at which the slope error is examined.

In an embodiment, at least 50% of the area of the glass window for length scales above 15 mm, in particular for length scales between 15 mm and the half of the circumference (U/2) in mm of a ring-shaped glass window may have an optical slope error SE_{O} for which the following applies:

SE_{O}<−2.4·10⁻⁶·2·R₀[1/mm]+4.9·10⁻³;

preferably SE_{O}<−1.2·10⁻⁶·2·R₀[1/mm]+2.5·10⁻³;

preferably SE_{O}<−4.8·10⁻⁶·2·R₀[1/mm]+9.8·10⁻⁴,

wherein SE_{O} is the dimensionless optical slope error and R₀ is the target value of the radius of curvature (in mm) of the glass window. In particular, R₀ can be the target value of the radius of curvature of the glass window at the position of the glass window at which the slope error is examined.

In an embodiment, the glass window may have a target value of the radius of curvature of R₀=42.5 mm. For example, the glass window may have a target value of the outer diameter OD=85 mm. In this case, for length scales above 15 mm, in particular for length scales between 15 mm and the half of the circumference (U/2) in mm of a ring-shaped glass window, 50% of the area of the glass window may have an optical slope error SE_{O} of less than 0.0029, preferably of less than 0.0014, preferably of less than 0.00057. In this embodiment, for example, the glass window may be a glass ring.

In an embodiment, the geometrical slope error may have a lower limit. So, for length scales above 15 mm, in particular for length scales between 15 mm and the half of the circumference (U/2) in mm of a ring-shaped glass window, at least 50% of the area of the glass window may have an optical slope error SE_{O} for which the following applies:

SE_{O}>−4.8·10⁻⁷·2·R₀[1/mm]+9.8·10⁻⁶;

preferably SE_{O}>−1.2·10⁻⁶·2·R₀[1/mm]+2.5·10⁻⁴;

preferably SE_{O}>−2.4·10⁻⁶·2·R₀[1/mm]+4.9·10⁻⁴,

wherein SE_{O} is the dimensionless optical slope error and R₀ is the target value of the radius of curvature (in mm) of the glass window. In particular, R₀ can be the target value of the radius of curvature of the glass window at the position of the glass window at which the slope error is examined.

In an embodiment ,the glass window may have a target value of the radius of curvature of R₀=42.5 mm. For example, the glass window may have a target value of the outer diameter OD=85 mm. In this case, for length scales above 15 mm, in particular for length scales between 15 mm and the half of the circumference (U/2) in mm of a ring-shaped glass window, 50% of the area of the glass window can have an optical slope error SE_{O} of at least 0.000057, preferably of at least 0.00014, preferably of at least 0.00029. In this embodiment, for example, the glass window may be a glass ring.

In an embodiment, for length scales above 15 mm, in particular for length scales between 15 mm and the half of the circumference (U/2) in mm of a ring-shaped glass window, at least 50% of the area of the glass window may have an optical slope error SE_{O} for which the following applies:

−4.8·10⁻⁷·2·R₀[1/mm]+9.8·10⁻⁵<SE_{O}<−2.4·10⁻⁵·2·R₀[1/mm]+4.9·10⁻³;

preferably −1.2·10⁻⁶·2·R₀[1/mm]+2.5·10⁻⁴<SE_{O}<−1.2·10⁻⁵·2·R₀[1/mm]+2.5·10⁻³;

preferably −2.4·10⁻⁶·2·R₀[1/mm]+4.9·10⁻⁴<SE_{O}<−4.8·10⁻⁶·2·R₀[1/mm]+9.8·10⁻⁴,

wherein SE_{O} is the dimensionless optical slope error and R₀ is the target value of the radius of curvature (in mm) of the glass window. In particular, R₀ can be the target value of the radius of curvature of the glass window at the position of the glass window at which the slope error is examined.

In an embodiment, for length scales above 15 mm, in particular for length scales between 15 mm and the half of the circumference (U/2) in mm of a ring-shaped glass window, at least 50% of the area of the glass window may have a geometrical slope error of less than 0.004, preferably less than 0.003, further preferably less than 0.0025, still further preferably less than 0.002 and/or an optical slope error of less than 0.002, preferably less than 0.0015, further preferably less than 0.00125, still further preferably less than 0.001. In particular, for length scales above 15 mm, in particular for length scales between 15 mm and the half of the circumference (U/2) in mm of a ring-shaped glass window, at least 50% of the area of the glass window may have a geometrical slope error of at least 0.0001, preferably at least 0.0002, further preferably at least 0.0003 and/or an optical slope error of at least 0.00005, preferably at least 0.0001, further preferably at least 0.00015.

For example, for the geometrical slope error in at least 50% of the area of the glass window for length scales above 15 mm, in particular for length scales between 15 mm and the half of the circumference (U/2) in mm of a ring-shaped glass window, the following relation may be true:

0<(ΔWT)/ΔL<X,

wherein WT is the wall thickness in mm and Lisa length (e.g. the circumference) in mm of the glass window and X is a variable for the above defined values. In particular, it may be that X=2·10⁻³.

For example, for length scales above 15 mm, in particular for length scales between 15 mm and the half of the circumference (U/2) in mm of a ring-shaped glass window, for the optical slope error in at least 50% of the area of the glass window a ring-shaped glass window, the following relation may be true:

0<(n−1)*(ΔWT)/ΔL<X,

wherein WT is the wall thickness in mm, L is a length (e.g. the circumference) in mm and n is the refractive index of the glass window and Xis a variable for the above defined values. In particular, it may be that X=1·10⁻³.

Preferably, for length scales above 15 mm, in particular for length scales between 15 mm and the half of the circumference (U/2) in mm of a ring-shaped glass window, the glass window has this tolerable maximum of the geometrical slope error or a geometrical slope error which is lower than this tolerable maximum and/or this tolerable maximum of the optical slope error or an optical slope error which is lower than this tolerable maximum in at least 60% of its area, preferably at least 70%, further preferably at least 80%, still further preferably at least 90%. In other words, the glass window has the high surface quality and performance which is described by the slope error in a sufficient extent in at least the part of the glass window which, when the glass window is used in an optical system, for example in a LiDAR system, is actively used from the system. In particular, in the case of LiDAR systems, this is the part of the glass window through which a laser light (emitted and reflected) passes.

Although the geometrical and the optical slope error for length scales between 15 mm and the half of the circumference of the glass window (U/2) in mm influence the signal quality less strongly than slope errors for length scales between 0.1 mm and 15 mm, nevertheless, the development can further improve the optical quality and system performance.

According to an embodiment, the glass window may be a ring or a ring segment. In other words, the glass window may have a form of a ring or a form of a ring segment, thus a form of a hollow cylinder or a form of a segment of a hollow cylinder. In this case, for the calculation of the slope error the outer surface of a mathematically perfect ring with consistently identical target value of the radius of curvature and/or consistently identical target value of the outer diameter can be used as reference area. A ring-shaped glass window, in particular a completely ring-shaped glass window can, for example, be used for spinning LiDAR systems in which emitter and detector rotate within the ring. The glass window may be composed of several curved glass areas. In particular, a complete ring may be composed of one or more ring segments. For example, a 360° ring may be composed of three 120° ring segments. It goes without saying that in an alternative the curved glass area, e.g. a ring segment, can be used as glass window, in particular as LiDAR window.

The glass window may have a target value of the radius of curvature of at least 25 mm, preferably of at least 50 mm and/or of at most 200 mm. In particular, the target value of the radius of curvature can be in the range of between 25 mm and 200 mm. In the case of a ring-shaped glass window, the target value of the radius of curvature may be the outer diameter of the glass window. The glass window may have a wall thickness of at least 1.0 mm and/or at most 5 mm, preferably in the range of between 1.0 mm and 5 mm. The wall thickness may depend on the total size of the glass window, wherein smaller glass windows normally have a lower thickness. An axial length of the glass window may be at least 15 mm and/or at most 200 mm, wherein, in particular, the length may be between 20 mm and 200 mm. The glass window may have an angle at center of between 30° and 360°, preferably between 60° and 270°, preferably between 90° and 120°. For example, three ring segments with an angle at center of 120° can be prepared from one ring. With respect to its dimensions, the glass window may be adjusted to the size of the LiDAR system in which the glass window should be used. In this connection the above values are advantageous values. The above dimensions and measures may, in particular, refer to implementations of the glass window as ring or ring segment.

Preferably, the glass window meets the following tolerances:

n=n₀±2.5%; and/or

OD=OD₀±1.0% (when WT is fixed); and/or

OD=OD₀±0.2% (when ID is fixed); and/or

ID=ID₀±0.2% (when OD is fixed),

wherein n is the true refractive index, n₀ is the target value of the refractive index, OD is the true outer diameter, OD₀ is the target value of the outer diameter, ID is the true inner diameter, ID₀ is the target value of the inner diameter and WT is the true wall thickness. OD may be the same as 2R and OD₀ may be the same as 2R₀. The given tolerances define advantageous one parameter tolerances, while the other parameters are assumed as being ideal.

The above geometrical parameters and contours can be measured with tactile sensors, such as e.g. the measuring instrument: Zeiss O-Inspec.

In an embodiment, at least 50% of the area of the glass window, preferably at least 60%, preferably at least 70%, further preferably at least 80%, still further preferably at least 90%, may have an RMS roughness (a so-called root-mean-squared roughness) of less than 10 nm, preferably less than 7.5 nm, preferably less than 5 nm. In particular, the RMS roughness can be less than 0.5% of the working wavelength, thus the wavelength of the relevant radiation which is used in the respective application. Thus, in LiDAR systems the value of the RMS roughness can be less than 0.5% of the wavelength of the used laser light (typically 905 nm, 940 nm or 1550 nm). Such an RMS roughness can further increase the surface quality and performance of the glass window and thus in addition improve the signal quality, when used in optical applications such as LiDAR systems. The RMS roughness (also referred to as roughness Rq) can be measured by means of white light interferometry, for example on an area of 300 μm×300 μm. A low RMS roughness in the mentioned ranges may, for example, be achieved by removal (e.g. grinding, polishing, etching) and/or application (e.g. coating of flatness imperfections), wherein flatness imperfections, for example, may be present due to drawing streaks in the surface of the glass window. The roughness can be determined according to DIN EN ISO 4287:2010.

In an embodiment, the glass window may substantially be opaque for visible light, i.e. at least for light with wavelengths of between 400 nm and 700 nm, and substantially be transparent for light with working wavelengths (for example laser light). The working wavelengths may be in the near infrared region of the spectrum (NIR), for example in a working wavelength range of between 780 nm and 3μm. A working wavelength may, in particular, be 905 nm, 940 nm and/or 1550 nm. “Substantially opaque” may mean that the glass window for light with the wavelengths mentioned for that has an average transmission (T_ave) of less than or equal to 10%, preferably less than 7.5%, preferably less than 5%. “Substantially transparent” may mean that the glass window for light with the wavelengths mentioned for that has an average transmission (T_ave) of 90% or higher, preferably of at least 92%, preferably between 92% and 94%.

In particular, the glass window may be substantially opaque for light with wavelengths of 700 nm or shorter. Preferably, the glass window may be substantially opaque for wavelengths of up to at most 80%, preferably up to at most 85%, further preferably up to at most 90% of the working wavelength of the light which is used in the respective application (for example a laser light with the wavelength 905 nm, 940 nm or 1550 nm). Preferably, the glass window may be substantially transparent for light with wavelengths of 800 nm or higher, for example for light with wavelengths of between 800 nm and 2500 nm, preferably between 800 nm and 1600 nm, in particular at least for laser light having wavelengths of about 905 nm, about 940 nm and/or about 1550 nm.

The glass window may have these and further optical properties and designs at least in a relevant region or in a sufficiently large area of at least 50%, preferably at least 60%, preferably at least 70%, further preferably at least 80%, still further preferably at least 90%, still further preferably at least 99%.

With the design of a glass window which is substantially opaque for certain wavelengths and only substantially transparent for other certain wavelengths, it can be guaranteed that optionally disturbing wavelengths during operation are blocked and do not reach the detector.

For realizing the opaque properties of the glass window, different developments of the glass window may be provided separately or in combination. So, in an embodiment, the glass window for absorption of visible light can be provided with a coating which is substantially opaque for visible light and is substantially transparent at least for light in the range of the working wavelengths (e.g. laser light). The coating may be organic or inorganic. Visually, the coating may be black. The coating may, for example, be a dip coating. In particular, the coating may substantially be opaque for visible light with wavelengths of 700 nm or lower. Preferably, the coating may substantially be opaque for visible light with wavelengths of at least 400 nm. For example, the coating may substantially be opaque at least for visible light with wavelengths of between 400 nm and 700 nm. Preferably, the coating may substantially be transparent at least for light with wavelengths of above 800 nm, in particular for light with wavelengths of about 905 nm, about 940 nm and/or of about 1550 nm.

In an alternative or in addition, the glass window for absorption of visible light may be provided with a foil which is substantially opaque for visible light and substantially transparent at least for light in the range of the working wavelengths (e.g. laser light). Visually, the foil can have a dark, for example black, appearance. For example, the foil may be a black polymer film. In particular, the foil can substantially be opaque for visible light with wavelengths of 700 nm or shorter. Preferably, the foil may substantially be opaque for visible light with wavelengths of at least 400 nm. For example, the foil may substantially be opaque at least for visible light with wavelengths of between 400 nm and 700 nm. Preferably, the foil may substantially be transparent at least for light with wavelengths of above 800 nm, in particular for light with wavelengths of about 905 nm, about 940 nm and/or of about 1550 nm.

In an alternative or in addition, the glass window may comprise volume colored glass (“black glass”). The glass window may be provided with one or more further layer/s. The glass window may comprise a heating layer. A heating layer may, for example, be used for removing frost on the glass window. The glass window may comprise a hydrophobic layer which has a water contact angle of higher than 90°. A hydrophobic layer may, for example, improve the draining of liquid droplets from the glass window. The glass window may comprise an anti-scratch layer for protecting the glass window from mechanical damages. The glass window may comprise a hydrophilic layer which has a water contact angle of lower than 90°. A hydrophilic layer may, for example, be used that a liquid which is in contact with the glass window forms a uniform film on the glass window.

The provision of visually black constituents of the glass window has the further advantage that it is possible to prevent that somebody from outside can look into the system. In addition, optionally sensible constituents of the systems, such as for example detectors, can be protected from incident solar radiation.

In the embodiments in which the glass window is provided with an additional coating, foil, polymer layer, the glass window comprises at least two layers (glass and further layer). In such a case, the first layer or the glass material may have a high optical transmittance (e.g. of above 90%) for visible light and for light in the range of the working wavelengths, thus for example an optical transmittance of above 90% for light with wavelengths of up to at least 1600 nm, preferably up to at least 1000 nm, preferably up to at least 950 nm. The first layer may have the preferred RMS roughness, i.e. an RMS roughness of less than 10 nm, preferably less than 7.5 nm, preferably less than 5 nm. In particular, the RMS roughness of the first layer may be less than 0.5% of the working wavelength, thus the wavelength of the relevant radiation which is used in the respective application. Thus, in LiDAR systems the value of the RMS roughness can be less than 0.5% of the wavelength of the used laser light (typically 905 nm, 940 nm or 1550 nm). The second layer (e.g. coating, foil or polymer layer) may have the described properties of a low optical transmittance for visible light and a high optical transmittance for light in the range of the working wave lengths. The RMS roughness of the second layer may correspond to the RMS roughness of the first layer.

According to an embodiment, the glass window on an inner side (i.e. for example a side facing the emitter and detector during operation) and/or an outer side (i.e. for example a side facing the environment during operation) may be provided with an antireflection layer. The composite consisting of the glass window and the antireflection layer/s may be highly transparent for the working wavelengths, i.e. in particular in the near infrared region of the spectrum (NIR). In other words, the antireflection layer/s can reduce reflection losses for light in the working wavelength range at the air/glass interface and thus lead to a higher transmission of light in the working wavelength range. So, transmission of light in the working wavelength range (e.g. of laser radiation) through the glass window can be maximized, with respect to the emission towards outside and also with respect to the transmission of radiation which is reflected back to the detector from the environment. For example, with one/several additional antireflection layer/s for the working wavelengths an average transmission (T_ave) of the glass window of at least 95% (in the case of a coating on one side), preferably of at least 98% (in particular in the case of coatings on both sides) can be achieved. It goes without saying that the glass window may comprise an antireflection layer system (AR layer system) which comprises several antireflection layers with the above properties. An AR layer system is capable of covering broader wavelength ranges than single AR layers.

According to an embodiment, the glass window may comprise borosilicate glass, aluminosilicate glass, such as e.g. alkali aluminosilicate glass or alkaline earth aluminosilicate glass.

It may be that the glass is prestressed or can be prestressed.

Preferable materials of the glass window may have the following composition ranges in % by weight:

| Constituent | % by weight |
|---|---|
| SiO₂ | 55 to 81 |
| B₂O₃ | 0 to 15 |
| Al₂O₃ | 0 to 25 |
| R₂O | 0 to 20 |
| RO | 0 to 15 |

In an embodiment, the glass is selected from borosilicate glass (e.g. with high hydrolytic resistance) and aluminosilicate glass, such as for example boron-free and/or alkali-free aluminosilicate glass, or sodium containing aluminosilicate glass. Exemplary compositions which can be used according to the present disclosure can be found in the following table.

| | Composition ranges (% by weight) | | | | |
|---|---|---|---|---|---|
| | SiO₂ | Al₂O₃ | B₂O₃ | R₂O | RO |
| borosilicate glass with high | 70-81 | 1-10 | 6-14 | 0-10 | 0-5 |
| hydrolytic resistance | | | | | |
| (“neutral glasses”) | | | | | |
| boron- und alkali-free | 55-75 | 11-25 | 0 | 0-20 | |
| aluminosilicate glass | | | | | |
| aluminosilicate glass which | 64-78 | 4-14 | 0-4 | 0-14 | 0-15 |
| contains high amounts of | | | | | |
| Na and can be chem. | | | | | |
| prestressed | | | | | |

“R₂O” means alkali metal oxides selected from Li₂O, Na₂O and K₂O. “RO” means metal oxides selected from MgO, ZnO, CaO, BaO and SrO.

In an embodiment, the glass has a refractive index n_{d} of at least 1.450, in particularly at least 1.500. The refractive index may have a value of up to 1.750 or up to 1.650.

An optional chemical prestressing under ion exchange is, for example, conducted by immersion into a potassium containing salt melt. Also, an aqueous potassium silicate solution, paste or dispersion can be used or an ion exchange by vapor deposition or temperature-activated diffusion can be conducted. Normally, the first mentioned method is preferred. The chemical prestressing is inter alia characterized by the parameters compressive stress and depth of penetration:

“Compressive stress” or “surface stress” (CS) mean the stress resulting from the displacement effect onto the glass network through the glass surface after an ion exchange process, while no deformation in the glass occurs.

“Depth of penetration” or “depth of layer” or “depth of ion exchanged layer” (DoL) mean the thickness of the glass surface layer in which ion exchange occurs and compressive stress is created. The compressive stress CS and the depth of layer DoL respectively can, for example, be measured on the basis of optical principles with the commercially available stress measuring apparatus FSM6000.

Therefore, the ion exchange means that the glass is hardened or chemically prestressed by ion exchange methods, a method which is well known for a person skilled in the art (from prior art) in the field of glass refinement and/or processing. The typical salt which is used for chemical prestressing is, for example, molten K⁺ containing salt or mixtures of salts. Conventionally used salts comprise KNO₃, KCl, K₂SO₄or K₂Si₂O₅; additives, such as NaOH, KOH and other sodium salts or potassium salts are also used for better controlling or regulating the rate of the ion exchange for the chemical prestressing.

In an embodiment, the glass window may comprise a chemically and/or thermally prestressed material. In this embodiment, a depth of layer (DoL) of the prestress layer of between 10 μm and 100 μm, preferably between 25 μm and 75 μm, preferably of about 50 μm may be formed. The prestress may be at least 100 MPa, preferably at least 200 MPa, preferably at least 300 MPa. The prestress may be lower than 1500 MPa, for example lower than 1000 MPa. The prestress may strongly increase the mechanical durability of the glass window. Chemical prestress may, in particular, be achieved by ion exchange of sodium ions with potassium ions or of lithium ions with sodium and/or potassium ions. The ion exchange may be realized by treatment of the material with a respective salt at increased temperature, at about 350 to 550° C., e.g. of 400 to 480° C. Suitable salts are e.g. nitrates and halides of the respective ions, e.g. KNO₃, KCl, NaNO₃, NaCl and mixtures thereof. The duration of the treatment depends on the desired depth of layer. The duration of the treatment may be at least 2 hours, at least 4 hours or at least 5 hours. Optionally, the duration is limited to at most 16 hours, at most 12 hours or at most 8 hours.

A further aspect relates to a LiDAR system comprising a laser light source for emitting laser light, in particular with a working wavelength of 905 nm, 940 nm or 1550 nm, a scanning device for deflecting the laser light, a detection device for detecting reflected laser light and a glass window of the above described kind. The glass window may be integrated in a casing of the LiDAR system.

It goes without saying that the LiDAR system still comprises further components, such as for example a lens arrangement for focusing, deflecting, redirecting, etc. the emitted light and/or an evaluation device.

A further aspect of the disclosure relates to a method for the production of a glass window for optical systems, in particular for the production of a glass window of the above described kind. The method comprises the following steps in any desired order:
forming of a curved glass area, in particular a glass ring and/or a glass ring segment, for the use as glass window;
grinding and/or polishing of at least a section of the curved glass area for adjusting in at least 50% of the curved glass area a geometrical slope error of less than −2.3·10⁻⁶·2·R₀[1/mm]+7.3·10⁻⁴ (i.e. SE_{G}<−2.3·10⁻⁶·2·R₀[1/mm]+7.3·10⁻⁴) for length scales between 0.1 mm and 15 mm, and preferably an optical slope error of less than −1.1·10⁻⁶·2·R₀[1/mm]+3.6·10⁻⁴ (i.e. SE_{G}<−1.1·10⁻⁶·2·R₀[1/mm]+3.6·10⁻⁴) for length scales between 0.1 mm and 15 mm.

In an embodiment, the method may comprise the following steps:
drawing of a glass tube from a glass melt;
grinding and/or polishing of at least a section of the glass tube for adjusting in at least 50% of the area of a section which is used as glass window a geometrical slope error of less than −2.3·10⁻⁶·2·R₀[1/mm]+7.3·10⁻⁴ (i.e. SE_{G}<−2.3·10⁻⁶·2·R₀[1/mm]+7.3·10⁻⁴) for length scales between 0.1 mm and 15 mm, and preferably an optical slope error of less than −1.1·10⁻⁶·2·R₀[1/mm]+3.6·10⁻⁴ (i.e. SE_{G}<−1.1·10⁻⁶·2·R₀[1/mm]+3.6·10⁻⁴) for length scales between 0.1 mm and 15 mm; and
cutting of the glass tube for generating one or several rings with a predetermined length, wherein the one or the several rings preferably are cut into glass segments (ring segments). The glass segments may have an angle at center of between 60° and 270°. The ring/s or one, several or all glass segment/s may then be used as glass window for optical systems, in particular for LiDAR systems.

In an embodiment, the method may comprise the following steps:
hot forming of a flat glass for forming at least sectionally a curved glass window, in particular in the form of a ring segment;
grinding and/or polishing of at least a section of the curved glass window or the ring segment for adjusting in at least 50% of the area of the curved glass window or the ring segment a geometrical slope error of less than −2.3·10⁻⁶·2·R₀[1/mm]+7.3·10⁻⁴ (i.e. SE_{G}<−2.3·10⁻⁶·2·R₀[1/mm]+7.3·10⁻⁴) for length scales between 0.1 mm and 15 mm, and preferably an optical slope error of less than −1.1·10⁻⁶·2·R₀[1/mm]+3.6·10⁻⁴ (i.e. SE_{O}<−1.1·10⁻⁶·2·R₀ [1/mm]+3.6·10⁻⁴) for length scales between 0.1 mm and 15 mm.

is The ring segment may have an angle at center of between 60° and 270°.

In an optional further step, the curved glass area together with one or more further curved glass areas can be assembled into a glass window. In particular, a ring segment can be connected with one or more further ring segments to a complete ring, wherein, for example, three 120° ring segments can be assembled into a 360° ring. It goes without saying that in an alternative the curved glass area, e.g. a ring segment, can be used as glass window, in particular as LiDAR window.

In an embodiment, the glass tube or the ring segment can be postprocessed in geometry and surface (e.g. by grinding and/or polishing) such that the glass window does not exceed the preferred geometrical slope error and/or the preferred optical slope error in at least 60% of its area, preferably in at least 70%, preferably in at least 80%, further preferably in at least 90%.

Preferably, by the post-treatment a geometrical slope error of SE_{G}<−1.1·10⁻⁶·2·R₀[1/mm]+3.6·10⁻⁴, preferably of SE_{G}<−6.8·10⁻⁷·2·R₀[1/mm]+2.2·10⁻⁴, and/or of SE_{G}>−6.8·10⁻⁸·2·R₀[1/mm]+2.2·10⁻⁵, preferably of SE_{G}>−1.1·10⁻⁷·2·R₀[1/mm]+3.6·10⁻⁵, preferably of SE_{G}>−2.3·10⁻⁷·2·R₀[1/mm]+7.3·10⁻⁵ can be provided for length scales between 0.1 mm and 15 mm.

Preferably, by the post-treatment a geometrical slope error of less than 0.00040, preferably less than 0.00035, further preferably less than 0.00025(=2.5·10⁴) and/or of at least 0.00001, preferably at least 0.000025, preferably at least 0.00004 can be provided for length scales between 0.1 mm and 15 mm.

Preferably, by the post-treatment an optical slope error of SE_{O}<−5.6·10⁻⁷·2·R₀[1/mm]+1.8·10⁻⁴, preferably SE_{O}<−3.4·10⁻⁷·2·R₀[1/mm]+1.1·10⁻⁴, and/or of SE_{O}>−3.4·10⁻⁸·2·R₀[1/mm]+1.1·10⁻⁵, preferably of SE_{O}>−5.6·10⁻⁸·2·R₀[1/mm]+1.8·10⁻⁵, preferably of SE_{O}>−1.1·10⁻⁷·2·R₀[1/mm]+3.6·10⁻⁵ can be provided for length scales between 0.1 mm and 15 mm.

Preferably, by the post-treatment an optical slope error of less than 0.00020, preferably less than 0.00018, further preferably less than 0.00013(=1.3·10⁻⁴) and/or of at least 0.00001, preferably at least 0.000025, preferably at least 0.00004 can be provided for length scales between 0.1 mm and 15 mm.

In this disclosure, “grinding” means a process in which by a material removal the geometrical (long wave) form of a tool by means of an abrasive medium (e.g. bonded corn or lose corn) is reproduced. “Polishing” means a mechanical and/or thermo-mechanical and/or chemo-mechanical process which improves the short wave properties of the surface in a targeted manner. Here, according to the quality requirements both process steps in series, or each one alone, can be conducted.

Here, dependent on the product geometry the methods in their geometrical characteristic can be of large-scale design so that the tool during the treatment touches a large part of the area to be adjusted. This should preferably be 20% of the product area. In an alternative, also locally working tools can be used which, in particular in the case of multiaxially curved areas allow a sufficient two-dimensional treatment. In the field of optical elements such processes are known as “zonal polishing”.

By the post-treatment, a surface of an inner side (i.e. for example a side facing the emitter and detector during subsequent operation) and/or a surface of an outer side (i.e. for example a side facing the environment during subsequent operation) can be provided with the desired optical quality. The length of the rings into which the glass tube is cut may be a length which is optimized with respect to the post-treatment, in particular the grinding and/or polishing process.

By the grinding and/or polishing of the glass tube or the ring segment, surface material is removed, wherein at the same time an optically smooth surface with an RMS roughness of less than 10 nm, preferably less than 7.5 nm, preferably less than 5 nm can be provided. In particular, by the grinding and/or polishing wall thickness fluctuations on large length scales (several millimeters) and drawing streaks on the glass surface can be eliminated or at least reduced to an extent which is not significant for the application so that particularly low slope errors can be realized.

In addition or in an alternative to the grinding and/or polishing, the post-treatment of the glass tube or the ring segment can be conducted by etching for achieving the desired surface properties and the desired optical quality of the glass window.

Depending on the quality of the drawn tube or the hot-formed ring segment by grinding processes and/or other post-treatment processes further geometrical parameters can or have to be optimized, such as for example the outer diameter, the inner diameter, the concentricity, the roundness, and the like.

In an embodiment of the method, the spectral-optical properties of the glass window (or the glass tube, the ring or the ring segment) can be adjusted by means of coatings.

For this purpose, the method may comprise the further step of applying one or more antireflection layer/s (AR layer) onto the glass window, in particular onto the outer side of the glass window. The application of the antireflection layer/s may lead to the fact that the composite consisting of the glass window and the antireflection layer/s becomes highly transparent in the near infrared (NIR), in particular for the intended working wavelengths. For example, the composite may have a reflection degree of lower than 4%, preferably lower than 3%, preferably lower than 2%, in particular for working wave lengths in the near infrared region of the spectrum (NIR), for example for working wavelengths of 905 nm, 940 nm or 1550 nm. In other words, the antireflection layer/s can reduce reflection losses for light in the working wavelength range at the air/glass interface and thus lead to a higher transmission of light in the working wavelength range. The applied antireflection layer may be a layer system.

In addition or in an alternative, the method may comprise the further step of applying one or more layers onto the glass window which for visible light are substantially opaque and for light in the range of the working wavelengths are substantially transparent. In particular, this/these layer/s can be applied onto the inner side of the glass window. The layer/s can be a coating, a laminated foil and/or a polymer area (e.g. a polymer ring/polymer ring segment). Visually, the layer/s can be black and transparent in the near infrared region of the spectrum (NIR). A layer which is nontransparent in the visible spectral range may have cosmetic advantages, because so it is not possible to have a look into the optical application (e.g. LiDAR system), and may have technical advantages, because so solar radiation can be prevented from penetrating into the optical system so that the detectors are not glared and the signal to be recorded is not disturbed.

Although some of the above features, effects, advantages, embodiments and developments are only described with respect to the glass window according to the present disclosure, they accordingly also pertain to the method according to the present disclosure as well as the LiDAR system according to the present disclosure and vice versa. In particular, the method according to the present disclosure may comprise further steps for providing the properties, parameters and values described with respect to the glass window according to the present disclosure.

### BRIEF DESCRIPTION OF THE FIGURES

Below, embodiment examples of the present disclosure are explained in more detail with respect to the attached schematic figures.

FIG. 1 shows a schematic view of a section of a glass window for the explanation of the geometrical slope error.

FIG. 2 shows a diagram with comparative measurements for the signal quality, wherein glass windows of prior art and of the disclosure are used.

FIG. 3 shows an exemplary shot of a measurement of an optical slope error on a glass area.

### DETAILED DESCRIPTION OF THE DRAWINGS

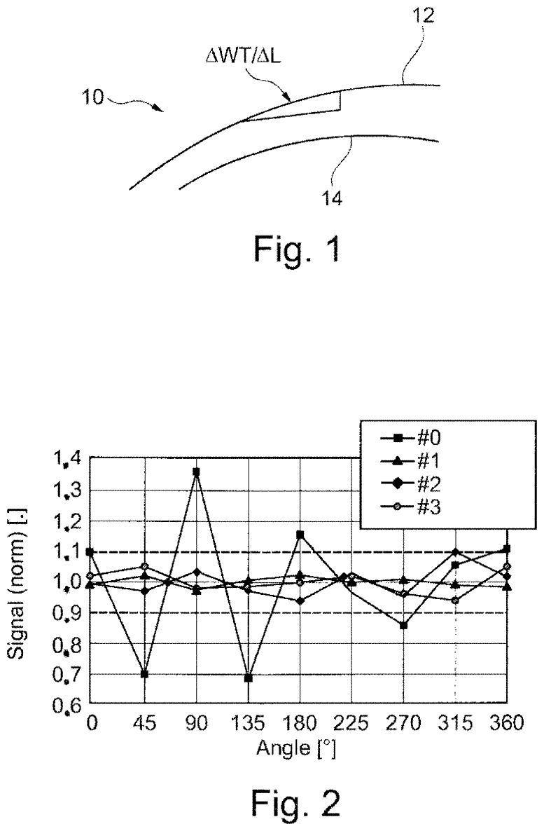

FIG. 1 shows a schematic section of a glass window 10 which should only serve for illustrating a geometrical slope error ΔWT/ΔL. So, for a better overview FIG. 1 shows only a one-sided change of the contour at an outer side. However, it is understood that in the sense of the disclosure for the slope error a wall thickness change is relevant which results collectively from errors and/or contour changes of the outer and inner contour.

The glass window 10 outwardly has a convex curvature. A first surface 12 of an outer side of the glass window 10 and a second surface 14 of an inner side of the glass window 10 can be seen. Regarded along a length, here the circumference, the glass window 10 has a wall thickness fluctuation or wall thickness change. By the change of the wall thickness (WT) over a length or here circumference section of a certain length scale (ΔL) the glass window in this section has a local slope deviation from an ideal target value of curvature.

The inventors of the present disclosure have discovered that a slope error in a glass window, in particular above a certain upper limit, has considerable negative effects onto the use of the glass window in optical systems and instruments, particularly in LiDAR systems. By the present disclosure, a glass window is provided which is suitable for the use in LiDAR systems and in particular minimizes a signal fluctuation and keeps it within a sufficient tolerance range of +/−10%.

A comparison of experimentally determined signal fluctuations in the case of the use of three glass windows according to embodiments of the disclosure and a prior art glass window in a LiDAR system is shown in FIG. 2. In the legend of FIG. 2 the prior art glass window is identified as #0, while the glass windows of the three embodiments of the disclosure in the legend of FIG. 2 are identified as #1, #2 and #3. Here, the prior art glass window identified with #0 was a glass ring originating from a drawn glass tube.

In FIG. 2 can be seen that the determined LiDAR signal in the case of the use of the prior art glass window (glass ring) fluctuated around a mean value in an extent of about +/−30%. Such a strong fluctuation is outside a tolerance range of about +/−10% which is considered as reasonable, for which reason the prior art glass window is not suitable for a use in a LiDAR system. In FIG. 2, the limits of the tolerance range which is considered as reasonable are shown as dashed lines.

In contrast to the prior art glass window, the determined measuring results show that the determined LiDAR signals in the case of the use of glass windows (glass rings) according to embodiments of the disclosure fluctuate in a range of at most +/−10%. Thus, when a glass window according to the present disclosure is used in a LiDAR system, the LiDAR signals are within the tolerance range of about +/−10%. Thus, the glass windows according to the present disclosure are suitable for a use in LiDAR systems and at the same time overcome the disadvantages of polymer windows.

The fluctuations of the determined LiDAR signal can also be expressed via the standard deviation with respect to the mean value which is shown in the following table:

Standard deviation

| | |
|---|---|
| glass ring of prior art | 0.22 |
| glass ring according to the present | 0.02 |
| disclosure of the first embodiment | |
| glass ring according to the present | 0.05 |
| disclosure of the second embodiment | |
| glass ring according to the present | 0.04 |
| disclosure of the third embodiment | |

### EXAMPLES

A first example of an embodiment of a glass window according to the present disclosure has the form of a complete ring (360°) with a target value of the outer diameter of 85 mm and a target value of the wall thickness of 2.0 mm. A second example of a further embodiment of a glass window according to the present disclosure has the form of a complete ring (360°) with a target value of the outer diameter of 135 mm and a target value of the wall thickness of 2.0 mm. In both examples, the glass window is intended for a use in a LiDAR system with a laser having a working wavelength of 905 nm and has the following measures and parameters:

Properties and parameter values of the glass
ring according to the present disclosure

| | First example | Second example |
|---|---|---|
| OD₀ or 2R₀ [mm] | 85.00 | 135.00 |
| OD [mm] with WT = constant | 85.00 ± 1.00 | 135.00 ± 1.50 |
| OD [mm] with ID = constant | 85.00 ± 0.20 | 135.00 ± 0.30 |
| WT [mm] with ID = constant | 2.00 ± 0.10 | 2.00 ± 0.15 |
| WT [mm] with OD = constant | 2.00 ± 0.10 | 2.00 ± 0.15 |
| ID [mm] with OD = constant | 81.00 ± 0.20 | 131.00 ± 0.30 |
| n | 1.5089 ± 0.04 | 1.5089 ± 0.04 |
| RMS roughness [nm] | <5 | <5 |
| (surfaces of the inner and | | |
| outer sides) | | |
| max. SE_{G} for length scales | 0.0005 | 0.0004 |
| between 0.1 mm and 15 mm | | |
| max. SE_{G} for length scales | 0.0057 | 0.0033 |
| above 15 mm | | |

wherein OD is the true outer diameter, OD₀ is the target value of the outer diameter, ID is the true inner diameter, ID₀ is the target value of the inner diameter, WT is the true wall thickness, n is the refractive index and SE_{G} is the geometrical slope error. As stated, the tolerances are the one parameter tolerances, wherein in such a case the other given parameters are assumed as ideal.

In this embodiment, the material of the glass window according to the present disclosure is DURAN® glass having an approximate composition (in % by weight) of:

| SiO₂ | B₂O₃ | Na₂O + K₂O | Al₂O₃ |
|---|---|---|---|
| 81 | 13 | 4 | 2 |

The RMS roughness, the geometrical slope error and the optical slope error have been adjusted by means of a post-treatment by grinding and polishing of the glass ring on the inner and outer sides.

The geometrical and the optical slope error were measured with the measuring instrument “Zygo Verifire” and the software “MX Software” of the company Zygo.

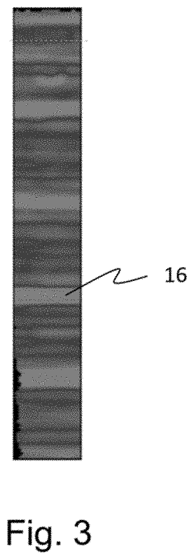

An exemplary shot of a measurement of the optical slope error on a glass area is shown in FIG. 3. The highest optical slope error SE₀, which was measured in this shot, can be found in region 16 and is 0.0004 for length scales between 0.1 mm and 15 mm.

### LIST OF REFERENCE SIGNS

10 glass window

12 first surface

14 second surface

16 region with the highest optical slope error

1. A glass window for optical systems,
wherein the glass window has a curved form, and
wherein for length scales between 0.1 mm and 15 mm, at least 50% of the area of the glass window has a geometrical slope error SE_{G} for which the following applies:
SE_{G}<−2.3·10⁻⁶·2·R₀[1/mm]+7.3·10⁻⁴,
wherein R₀ is the target value of the radius of curvature in mm of the glass window.

2. The glass window according to claim 1, wherein for length scales between 0.1 mm and 15 mm, at least 50% of the area of the glass window has a geometrical slope error of less than 0.00050.

3. The glass window according to claim 1, wherein for length scales between 0.1 mm and 15 mm, at least 50% of the area of the glass window has an optical slope error SE_{O} for which the following applies:
SE_{G}<−1.1·10⁻⁶·2·R₀[1/mm]+3.6·10⁻⁴.

4. The glass window according to claim 1, wherein for length scales between 0.1 mm and 15 mm, at least 50% of the area of the glass window has an optical slope error of less than 0.00025.

5. The glass window according to claim 1, wherein for length scales above 15 mm, at least 50% of the area of the glass window has a geometrical slope error SE_{G} for which the following applies: SE_{G}<−4.8·10⁻⁵·2·R₀[1/mm]+9.8·10⁻³; and/or the glass window has an optical slope error SE_{O} for which the following applies: SE_{O}<−2.4·10⁻⁵·2·R₀[1/mm]+4.9·10⁻³.

6. The glass window according to claim 1, wherein the glass window is a ring or a ring segment.

7. The glass window according to claim 1, wherein at least one of the following conditions applies:
the target value of the radius of curvature is between 50 mm and 200 mm;
the glass window has a wall thickness between 1 mm and 5 mm;
the glass window has an axial length between 20 mm and 200 mm;
the glass window has a center angle between 30° and 360°.

8. The glass window according to claim 1, wherein at least 50% of the area of the glass window has an RMS roughness of less than 10 nm.

9. The glass window according to claim 1, wherein the glass window for visible light in a wavelength range between 400 nm and 700 nm and has an average transmission of less than 10%, and for light with working wavelengths in the near infrared region of the spectrum, has an average transmission of 90% or higher.

10. The glass window according to claim 9, wherein the glass window for the absorption of visible light is provided with a coating, and wherein the coating, in a wavelength range of between 400 nm and 700 nm, has an average transmission of less than 10% and for light with working wavelengths in the near infrared region of the spectrum has an average transmission of 90% or higher.

11. The glass window according to claim 9, wherein the glass window for the absorption of visible light is connected to a foil, and wherein the foil, in a wavelength range of between 400 nm and 700 nm, has an average transmission of less than 10% and for light with working wavelengths in the near infrared region of the spectrum has an average transmission of 90% or higher.

12. The glass window according to claim 9, wherein the glass window comprises black glass.

13. The glass window according to claim 1, wherein the glass window further comprises an antireflection layer on an inner side and/or an outer side.

14. The glass window according to claim 1, wherein the glass window comprises borosilicate glass or aluminosilicate glass.

15. The glass window according to claim 1, wherein the glass window comprises a chemically and/or thermally prestressed material.

16. A method for the manufacturing of a glass window for optical systems, wherein the method comprises the following steps:
forming a curved glass area for use as glass window; and
at least one of grinding and polishing of at least a section of the curved glass area so that at least 50% of the curved glass area has a geometrical slope error SE_{G} of SE_{G}<−2.3·10⁻⁶·2·R₀[1/mm]+7.3·10⁻⁴ for length scales between 0.1 mm and 15 mm, and an optical slope error SE_{O} of SE_{O}<−1.1·10⁻⁶·2·R₀[1/mm]+3.6·10⁻⁴.

17. The method according to claim 16, wherein in the step of grinding and/or polishing, a geometrical slope error of less than 0.00050 is adjusted in at least 50% of the curved glass area for length scales between 0.1 mm and 15 mm .

18. The method according to claim 17, wherein the step of forming the curved glass area comprises:
drawing of a glass tube from a glass melt; or
hot forming of a flat glass.

19. The method according to claim 16, further comprising the step of applying one or more antireflection layer(s) onto the curved glass area.

20. The method according to claim 16, further comprising the step of applying one or more layers onto the curved glass area that are substantially opaque for visible light and substantially transparent for light with working wavelengths in the near infrared region of the spectrum.
